(19) United States
(12) Patent Application Publication
(10) Pub. No.: US 2025/0173599 A1
(43) Pub. Date: May 29, 2025

(54) INTERPRETABILITY OF CLASSIFICATION MODEL OUTPUT

(71) Applicant: SAP SE, Walldorf (DE)

(72) Inventors: Vishal PUNJABI, Fremont, CA (US); Victor WYKOFF, Cupertino, CA (US); Marko NAVALA, Los Gatos, CA (US); John OXENBY, Höllviken (SE); Anne RAJ, Bangalore (IN); Preeti SINGH, Alpharetta, GA (US); Akhil Mohanan MAVILAKANDY, Sunnyvale, CA (US)

(21) Appl. No.: 18/519,549

(22) Filed: Nov. 27, 2023

(51) Int. Cl. G06N 20/00

(52) U.S. Cl. CPC G06N 20/00

(57) ABSTRACT

Systems include reception of input data comprising a value for each of a plurality of features, input of the input data to a trained model to determine a label and a confidence level, determination of a contribution of each feature to the label based on the model and the label, determination of a set of features based on the determined contributions, determination of labeled data instances, comprising a value for each of the plurality of features and a fixed label, determination, for each feature of the set, of a ratio of a number of the labeled data instances having the same value as the input data and the determined label to a number of labeled data instances having the same value as the input data and not the determined label, presentation of the determined label and the confidence level, and presentation of each feature and its determined ratio.

### BACKGROUND

Modern enterprises produce, use and store large amounts of data. The data may be stored in database tables, files or other data structures. Users interact with applications executing on servers (e.g., on-premise or cloud-based) to view, create and update the data. Interactions between the applications and the data are facilitated by metadata which describes the semantics of the data.

Applications may use machine learning models (e.g., as statistical models) to provide predictions to their users. A machine learning model may be trained based on data associated with an application, and then used to generate predictions based on new data. In the case of a classification model, the prediction identifies the probability that new data belongs to a particular class. For example, a set of data may be collected representing the operation of a network connection over a particular time period. A trained classification model may receive the data and predict whether the data represents a network attack or a normal connection.

Predictions from a classification model may be used to assist evaluations or approvals of certain data. For example, a classification model may be trained based on historical data to predict whether a new set of data (e.g., program code, a requisition, technical drawings) will be approved by a manager or other approver. Regardless of the accuracy of the trained model, organizations are hesitant to completely remove the approver from the approval process by substituting the prediction of the trained model for the judgement of the approver.

Accordingly, the predicted probability of approval may be used as a guide to assist the evaluation of the data by the approver. However, the predicted probability is only marginally helpful due to the myriad of factors involved in evaluating data for approval and the opacity of the model which outputs the predicted probability. Providing a predicted probability of approval may therefore fail to appreciably facilitate the approval process and may in fact hinder the process by confusing the approver.

Systems are desired to facilitate decision-making by improving the interpretability of classification model output.

### BRIEF DESCRIPTION OF THE DRAWINGS

FIG. 1 is a block diagram illustrating determination of classification model output, per-input data feature contributions to classification model output, and ratios of similar historical data instances for each feature according to some embodiments.

FIG. 2 is a flow diagram of a process to determine classification model output, per-input data feature contributions to classification model output, and ratios of similar historical data instances for each feature according to some embodiments.

FIG. 3 is a block diagram illustrating training a classification model based on labeled training data instances according to some embodiments.

FIG. 4 is a block diagram illustrating use of a trained classification model to determine an output based on input data according to some embodiments.

FIG. 5 is a tabular representation of per-input data feature contributions to classification model output according to some embodiments.

FIG. 6 is a user interface presenting classification model output, ratios of similar historical data instances for each feature, and per-input data feature contributions to classification model output according to some embodiments.

FIG. 7 is a block diagram of a procurement system to train a classification model and to determine and present classification model output, ratios of similar historical data instances for each feature, and per-input data feature contributions to classification model output according to some embodiments.

FIG. 8 is a user interface to create a purchase requisition according to some embodiments.

FIG. 9 is a user interface presenting an approval probability according to some embodiments.

FIG. 10 is a user interface presenting purchase requisition approval probabilities and approving purchase requisitions according to some embodiments.

FIG. 11 is a user interface presenting classification model output and ratios of similar historical data instances for features of a purchase requisition according to some embodiments.

FIG. 12 is a user interface presenting purchase requisitions filtered based on their approval probabilities according to some embodiments.

FIG. 13 is a user interface presenting details of a purchase requisition and an approval probability of the purchase requisition according to some embodiments.

FIG. 14 is a user interface presenting classification model output and ratios of similar historical data instances for features of a purchase requisition according to some embodiments.

FIG. 15 is a block diagram of a cloud-based system according to some embodiments.

### DETAILED DESCRIPTION

The following description is provided to enable any person in the art to make and use the described embodiments. Various modifications, however, will be readily-apparent to those in the art.

Some embodiments utilize a classification model trained to output a label based on labeled data instances. Upon receipt of unlabeled input data, the trained classification model outputs a label (i.e., a classification) and a confidence level associated with the classification. According to some embodiments, a contribution of each feature of the input data to the classification is determined based on the trained model and the label. For each of a plurality of the features of the input data, a ratio of historical labeled data instances having the determined label and the same value as the feature is determined. The label and the confidence level are presented, and also presented are descriptions of the plurality of features and their determined ratios. The features and their determined ratios may be presented based on their determined contributions to the classification, for example in descending order of contributions and/or along with their determined contributions.

Embodiments may therefore improve interpretability of model-generated classifications. The improved interpretability may facilitate decision-making based on the classifications to a greater degree than prior systems.

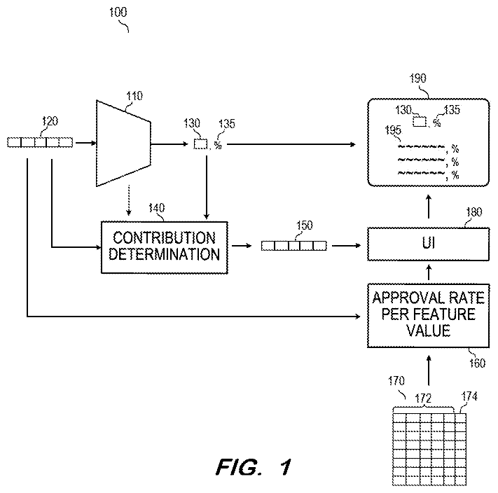

FIG. 1 is a block diagram illustrating system 100 to determine classification model output, contributions per-input data feature to classification model output, and ratios of similar historical data instances for each feature according to some embodiments. The illustrated components may be implemented using any suitable combination of computing hardware and/or software that is or becomes known. In some embodiments, two or more components are implemented by a single computing device. Two or more components of FIG. 1 may be co-located. One or more components may be implemented as a cloud service (e.g., Software-as-a-Service, Platform-as-a-Service). A cloud-based implementation of any components of FIG. 1 may apportion computing resources elastically according to demand, need, price, and/or any other metric.

Model 110 is a trained classification model as is known in the art. Upon receipt of unlabeled input data 120, trained classification model 110 outputs label (i.e., a classification) 130 and confidence level 135 associated with the classification 130. In some embodiments, trained model 110 is implemented by a cloud service and data 120 is input thereto and outputs 130, 135 are received therefrom via a Web API.

Model 110 may comprise any type of iterative learning-compatible network, algorithm, decision tree, etc., that is or becomes known. Model 110 may comprise a network of neurons which receive input, change internal state according to that input, and produce output depending on the input and internal state. The output of certain neurons is connected to the input of other neurons to form a directed and weighted graph. The weights as well as the functions that compute the internal states are iteratively modified during training using supervised learning algorithms. Model 110 may be implemented by a set of linear equations, executable program code, a set of hyperparameters defining a model structure and a set of corresponding weights, or any other representation of the mapping of input features to a label which was learned as a result of the training.

Input data 120 may be received from any source which desires to classify input data 120. Input data 120 of FIG. 1 includes five values, each of which corresponds to a respective “feature”. Each feature may correspond to a column of a database table storing values of each feature. In a simple example, the database table includes five columns and several rows, and input data 120 is one row of the table.

The features and their respective values may be derived from any one or more data sources and determined in any manner that is or becomes known. Feature engineering generally describes the selection and calculation of features for the express purpose of suitably training a specific model to infer a specific output. According to a few non-exhaustive examples, input data 120 may include values which are equal to a value of a database column, calculated based on values of two or more database columns, discrete values determined from database columns which store continuous values, etc.

Contribution determination component 140 may comprise program code executable to determine a contribution of each feature of input data 120 to the determination of classification 130. Contributions 150 may be determined based on model 110 and classification 130. In some embodiments, contributions 150 may comprise SHapely Additive explanations (i.e., SHAP values) for each feature of input data 120 as is known in the art.

Approval rate per feature value component 160 may comprise program code executable to determine a ratio for each feature of input data 120. The ratio is determined based on historical labeled data instances 170. Historical labeled data instances 170 may include data instances used to train or test model 110, instances obtained since training and/or testing, etc. Columns 172 of each instance (i.e., row) of instances 170 represent the same features as represented by input data 120. Column 174 of each row includes a classification associated with the values of the row.

The ratio determined by component 160 for a given feature is the ratio of historical labeled data instances 170 which are associated with classification 130 and whose value for the given feature is similar to the value of the given feature within input data 120 to all historical labeled data instances 170 whose value for the given feature is similar to the value of the given feature within input data 120.

For example, it is assumed that one of the features is “Cost” and column 174 includes the classifications “Approved” or “Not approved”. The values of the feature Cost within the rows of data instances 170 are binned (e.g., via feature engineering as described above) into ranges (e.g., 0: $0-$250, 1: $251-$1000, 2: $1001-$5000, etc.). It is also assumed that the value of the Cost feature of input data 120 is 1 and output classification 130 is Approved. Accordingly, in some embodiments, component 160 identifies rows of data instances 170 for which the value of the Cost feature is 1. Of these identified rows, component 160 identifies a percentage of rows for which the value of column 174 is Approved.

User interface (UI) component 180 is executable to generate UI 190 for presentation to a user. UI 190 presents classification 130 and confidence level 135, and also presents descriptions 195 of features and their corresponding ratios as determined by component 160. As shown, UI component 180 receives per-feature contributions 150. UI component 180 may use feature contributions 150 to determine which features to describe in descriptions 195 and/or the order in which to present the described features. For example, only the top 3 contributing features and their ratios may be presented, and/or the features may be presented in descending order of their contributions. Description 195 may also include the contribution of each feature.

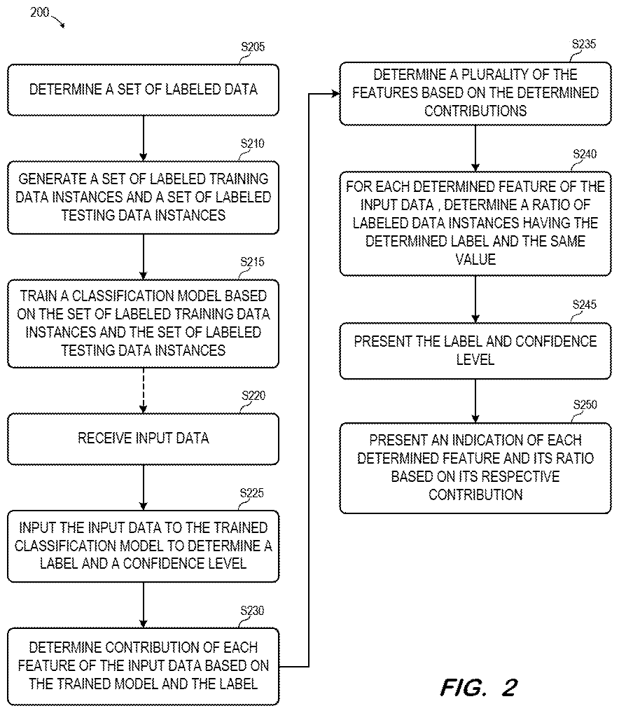

FIG. 2 comprises a flow diagram of process 200 determine classification model output, per-input data feature contributions to classification model output, and ratios of similar historical data instances for each feature according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. Embodiments are not limited to the examples described below.

A set of labeled data is determined at S205. The data may comprise records of a database table, and the records may comprise a query result based on one or more persisted database tables of a database, for example. In some embodiments, the set of labeled data comprises a random sampling of records from a much larger set of records. Each record or row of the set of labeled data is referred to herein as an instance and each instance includes a value of a corresponding column. The values may conform to any suitable data format.

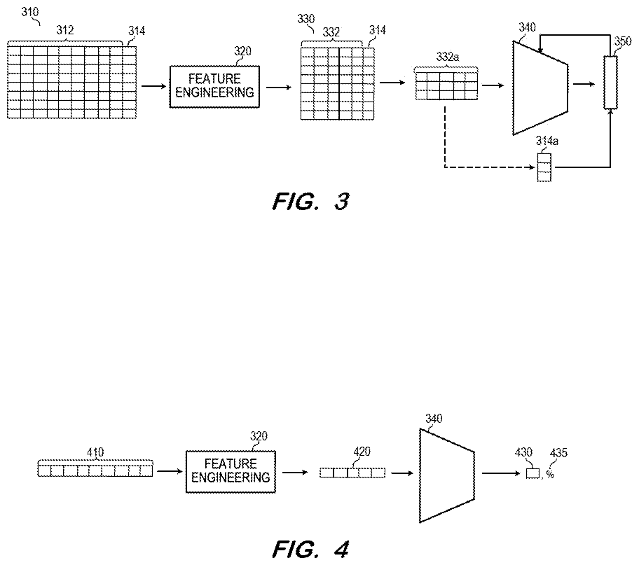

FIG. 3 is a block diagram illustrating training of a classification model according to some embodiments. Records 310 represent a labeled data set determined at S205. Each record includes values of data columns 312 and of label column 314.

A set of labeled training data instances and a set of labeled testing data instances are generated from the set of labeled data at S210. In some embodiments, S210 includes denoting some of records 310 as labeled training data instances and others of records 310 as labeled testing data instances. S210 may also include removing some of the columns of records 310 so that the labeled training data instances and labeled testing data instances do not include those columns. In some embodiments of S210, feature engineering component 320 derives features from columns of records 310 as is known in the art. Accordingly, the labeled training data instances and labeled testing data instances may include derived features, original columns, modified columns (e.g., conversion of continuous values to discrete values), etc.

At S215, a classification model is trained based on the set of labeled training data instances and the set of labeled testing data instances. FIG. 3 includes labeled training data instances 330 determined by feature engineering component 320 at S210 based on records 310. Each labeled training data instance 330 includes values of features 332 and label column 314.

Training at S215 may comprise execution of training iterations. One iteration according to some embodiments may include inputting a subset (i.e., a batch) of feature value instances 332a to model 340, operating model 340 to output a corresponding classification for each instance, operating loss layer 350 to evaluate a loss function based on the output classifications and known ground truth labels 314a of instances 332a, and modifying model 340 based on the evaluation. Iterations continue in this manner, with periodic testing of model 340 using the labeled testing data instances, until model performance is determined to be satisfactory.

The trained model is deployed for use after S215. Deployment may comprise exposing an API via which input data may be passed to the trained model and an output classification may be received therefrom, and/or adding the trained model to a set of models which may be accessed via such an API. The deployed model may consist of a set of linear equations, executable program code, a set of hyperparameters defining a model structure and a set of corresponding weights, or any other representation of the model's mapping of input features to a classification.

The dashed line between S215 and S220 represents possible temporal, administrative, and execution disconnects. That is, S220 may be executed well after S215 and without any synchronization therewith, S205-S215 may be initiated by a user different from the user who initiates S220, and S205-S215 may be executed by a different computing system than S220-S250.

Input data is received at S220. The input data may consist of several data values. For example, the input data may comprise a row of a database table. The input data may be received from a user who would like to classify the values using a model trained to make such classifications. If no trained model is available due to a lack of suitable training data (e.g., because the system has just been placed in productive operation), process 200 may terminate in some embodiments.

The input data is input to a trained classification model at S225 to determine a label and a confidence level. The classification model may have been trained on feature values engineered from data such as the input data. In such a case, values of the features expected as input by the trained model are generated from the input data prior to S225.

Continuing the example of FIG. 3, FIG. 4 illustrates input data 410 received at S220. Input data 410 may comprise values of the same columns 312 of data 310 used to train model 340. Feature engineering component 320 subjects data 410 to the same process as described above to generate feature values 420 corresponding to input data 410. Feature values 420 are input to trained model 340 at S225 to determine label 430 and confidence level 435 as is known in the art.

At S230, a contribution of each feature of the input data is determined based on the trained model and the determined label. As described above, S230 may comprise a determination of a SHAP value for each feature of feature values 420. S230 may comprise any other algorithm for determining per-feature contributions to a model-generated classification that is or becomes known. FIG. 5 illustrates determined contributions 500 for each of the five features of feature values 420 according to some embodiments.

A plurality of the features are determined based on the determined contributions at S235. According to some embodiments, S235 is intended to determine a subset of the features of the input data which will be presented to a user along with the determined classification and confidence level. The subset may include all of the features of the input data. Alternatively, the subset may be determined to include those features associated with the largest determined contributions to the output classification. With reference to contributions 500, the features associated with contributions 0.445 and 0.422 may be determined at S235. The number of features to be determined at S235 may be predefined, based on a threshold (i.e., all features having a contribution >X are determined), or determined based on any suitable analysis of the contributions.

For each feature determined at S235, a ratio of labeled data instances associated with the determined classification and the same value of the feature is determined at S240. With respect to FIGS. 3 and 4, the ratio determined for a given feature is the ratio of labeled data instances 310 which are associated with classification 430 and whose value for the given feature is the same as the value of the given feature within feature values 420 to all labeled data instances 310 whose value for the given feature is the same as the value of the given feature within feature values 420.

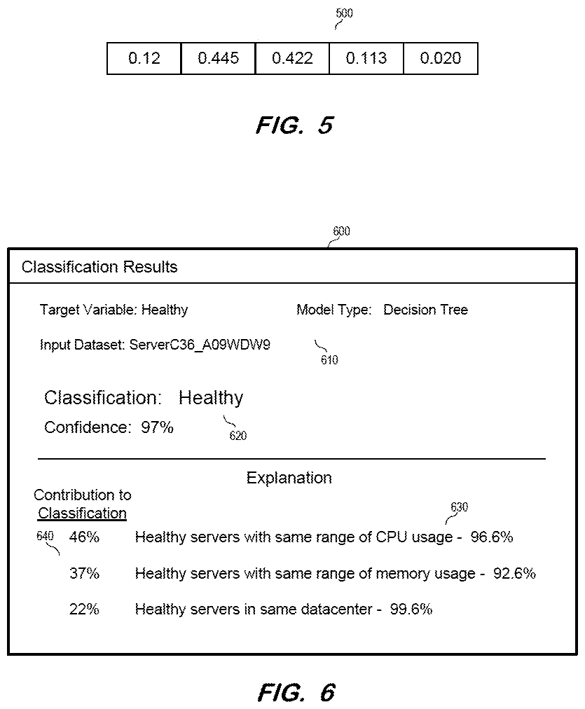

The determined classification and confidence level are presented at S245. FIG. 6 illustrates interface 600 presenting the classification results and the confidence level according to some embodiments. Interface 600 may be presented to a user by a client application (e.g., a Web application) which provides model inferences. Area 610 of interface 600 identifies an input dataset, model type and target variable (i.e., classification). Area 620 shows the determined classification and associated confidence level.

At S250, an indication of each feature determined at S235 and corresponding ratio determined at S240 is presented based on its respective contribution. Interface 600 presents an example of descriptions 630 of features (i.e., CPU usage, memory usage, datacenter) and their corresponding ratios (i.e., 96.6%, 92.6%, 99.6%). Moreover, interface 600 presents contributions 640 determined for each presented feature at S230. As shown, the features are listed in descending order of their contributions to the classification presented in area 620.

According to some embodiments, the contribution of a feature to the classification may be determined based on the SHAP value determined for the feature and on the SHAP value of a related feature which is deemed not substantially relevant to the classification. For example, in the case of an input purchase requisition, the feature ItemCurrency is related to the feature ItemPrice but perhaps not substantially relevant to classifying the purchase requisition as Approved or Not Approved. Other related features may include UnitOfMeasure/ItemQty and Domain/CommodityCode. Therefore, to determine the respective contributions of the features ItemPrice, ItemQty and CommodityCode to the classification, the SHAP values of the features ItemCurrency, UnitOfMeasure and Domain are added to the SHAP values of the features ItemPrice, ItemQty and CommodityCode, respectively. In sum embodiments, the contribution of a given feature is then determined as (SHAP_value/sum of all SHAP_values)*100.

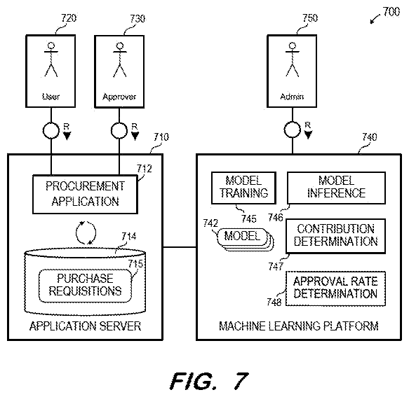

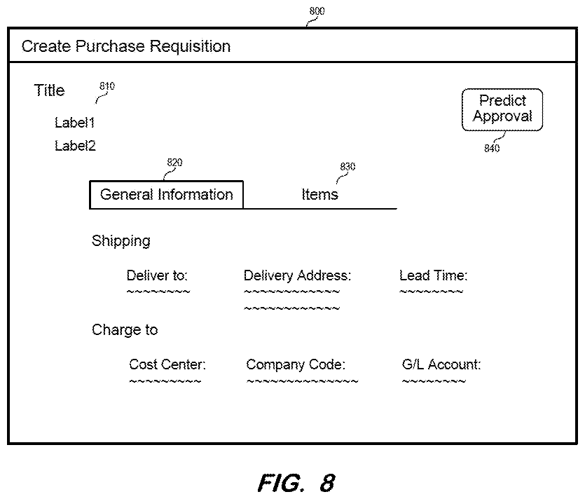

FIG. 7 illustrates system 700 according to some embodiments. System 700 is an example of specific use case of process 200. Embodiments are not limited to this use case.

Application server 710 of FIG. 7 may comprise an on-premise or cloud-based server providing an execution platform and services to applications such as procurement application 712. Procurement application 712 may comprise program code executable by a processing unit to provide functions to users such as user 720 and approver 730. For example, procurement application 712 may assist user 720 in creating a purchase requisition and submitting the purchase requisition for approval. Procurement application 712 may also present purchase requisitions 715 to approver 730 for approval. Moreover, procurement application 712 may perform some or all of process 200 to present predicted classifications (e.g., Approved/Not approved), confidence levels, features, feature ratios and feature contributions to user 720 during purchase requisition creation and to approver 730 during purchase requisition approval.

Data store 714 stores purchase requisitions 715 and may comprise any suitable storage system such as a database system. Data store 714 may be partially or fully remote from application server 710, and may be distributed as is known in the art. Data store 714 may store column-based data, row-based data, object data or any other type of data that is or becomes known.

Machine learning platform 740 supports machine learning model training and usage. Administrator 750 may access model training component 745 to request training of one of models 742 based on specified labeled data instances. Procurement application 712 may request an inference from a trained model based on input data from model inference component 746. According to some embodiments, model inference component 746 accesses contribution determination component 747 to determine per-feature contributions of the input data as described above and approval rate determination component 748 to determine ratios for selected features as described above.

FIG. 8 is a view of interface 800 which may be presented by a procurement application such as procurement application 712 according to some embodiments. Interface 800 may be used by a user to create a purchase requisition. Area 810 provides fields to specify metadata of a purchase requisition, while tabs 820 and 830 allow the user to specify other details of the purchase requisition.

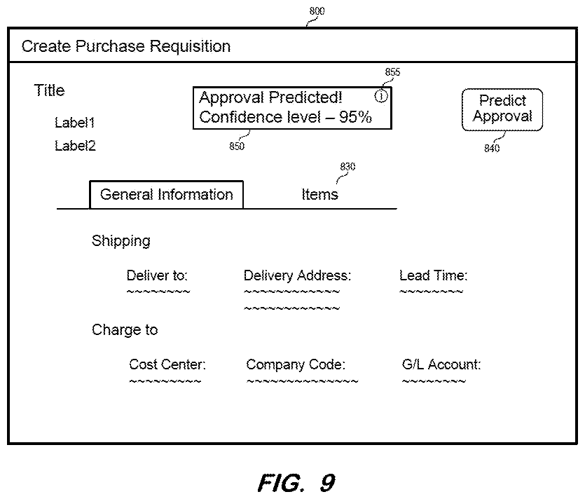

Predict Approval control 840 may be selected to obtain a prediction of whether the purchase requisition will be approved. FIG. 9 shows classification and confidence level 850 displayed on user interface 800 in response to selection of control 840. Classification and confidence level 850 may be obtained by submitting input data of the purchase requisition to a trained classification model as described above, where the label/classification of each labeled training data instance is Approved/Not Approved.

Information icon 855 may be selected (or hovered over) to cause presentation of features, feature approval ratios and feature contributions as described above. The prediction may assist the user in determining whether or not to submit the purchase requisition for approval as-is or to modify the purchase requisition. Moreover, the information presented via icon 855 may assist the user in determining modifications which may increase the likelihood of approval.

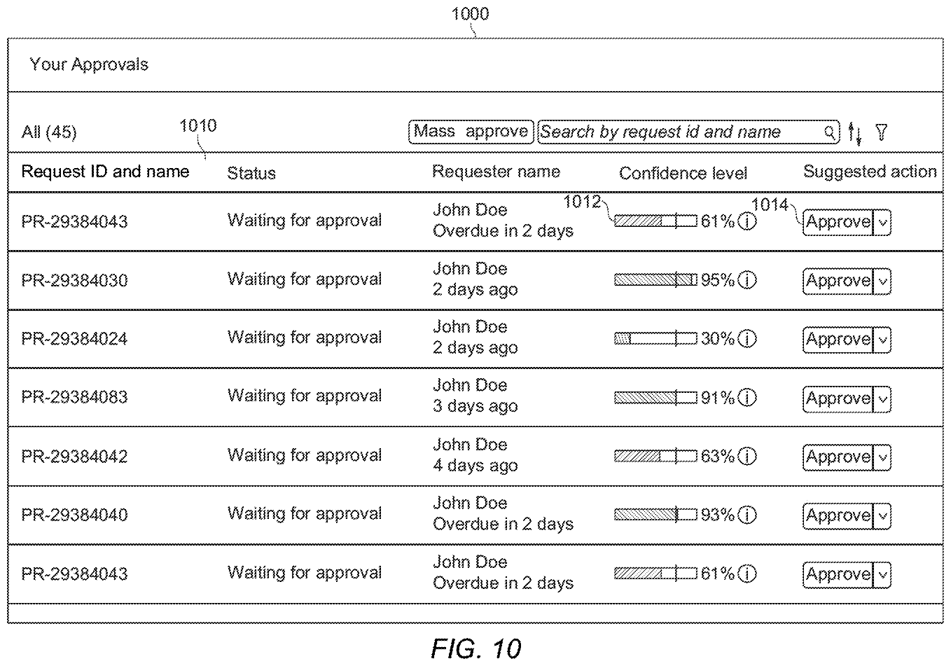

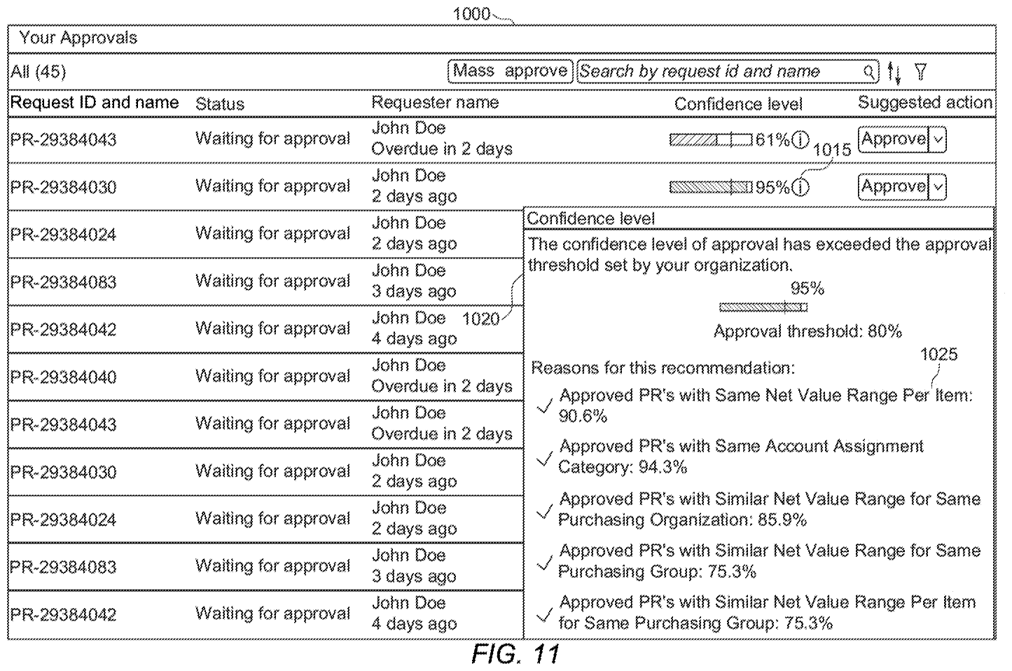

FIG. 10 illustrates user interface 1000 presented to an approver according to some embodiments. An approver may be presented with interface 1000 in response to accessing a task module of procurement application 712, for example. List 1010 of interface 1000 includes purchase requisitions assigned to the user, their approval status and associated requestor.

List 1010 also includes a confidence level 1012 for each purchase requisition. Each confidence level 1012 is determined by inputting data of the associated purchase requisition to a model trained on historical purchase requisition data (labeled Approved/Not Approved) as described above. Each of confidence levels 1012 is associated with the likelihood output by the model for the Approved classification. Accordingly, the 30% confidence level predicted by the model for purchase requisition PR-29384024 indicates that the model output a higher confidence level (e.g., >50%) that the purchase requisition would be Not Approved. In some embodiments, interface 1000 indicates, for each purchase requisition, the predicted classification (i.e., the classification having the highest confidence level) and its confidence level.

Interface 1000 includes Approve controls 1014 to facilitate approval of corresponding purchase requisitions. Interface 1000 therefore provides informed and quick approval of multiple purchase requisitions without human review of purchase requisition details.

However, in case further detail is needed, FIG. 11 illustrates window 1020 displayed upon user selection (or hovering over) of information icon 1015. A window such as window 1020 may also be presented upon selection of icon 855 of interface 800. Window 1020 presents information 1025 as described above with respect to descriptions 630. In particular, information 1025 describes per-feature approval ratios with respect to the input data. Information 1025 may be ordered based on the per-feature contributions of the input data to the classification (i.e., Approved). Information 1025 may further assist the approver in determining whether or not to approve the associated purchase requisition.

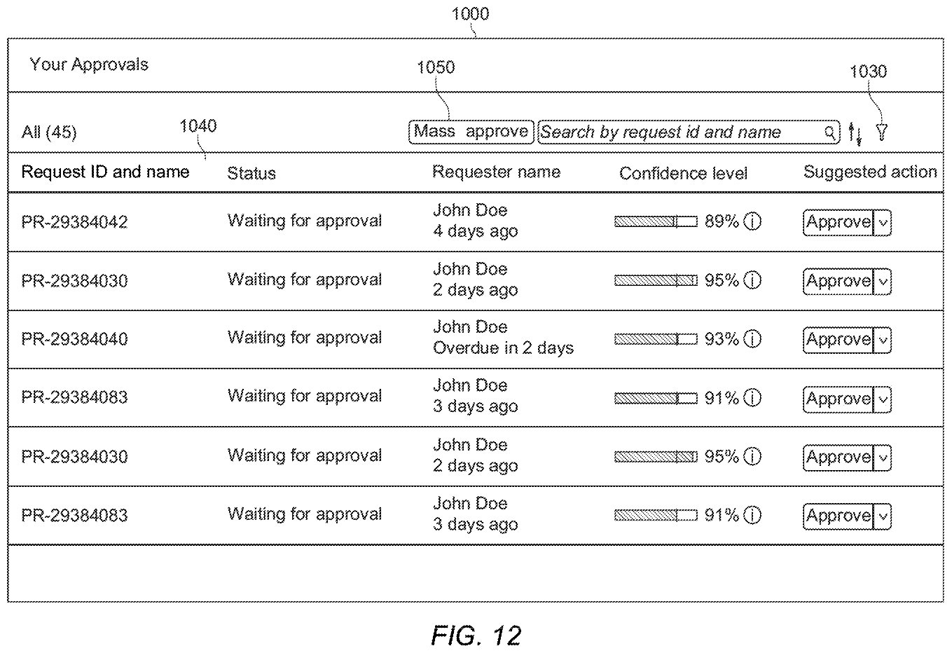

FIG. 12 is a view of interface 1000 after filtering the purchase requisitions of list 1010 based on confidence level. Filter icon 1030 may be selected to specify a confidence level threshold (e.g., 80%), resulting in filtered list 1040 consisting of purchase requisitions associated with confidence levels of >80% for the Approved classification. Advantageously, the approver may then select Mass Approve control 1050 to approve all purchase requisitions of list 1040.

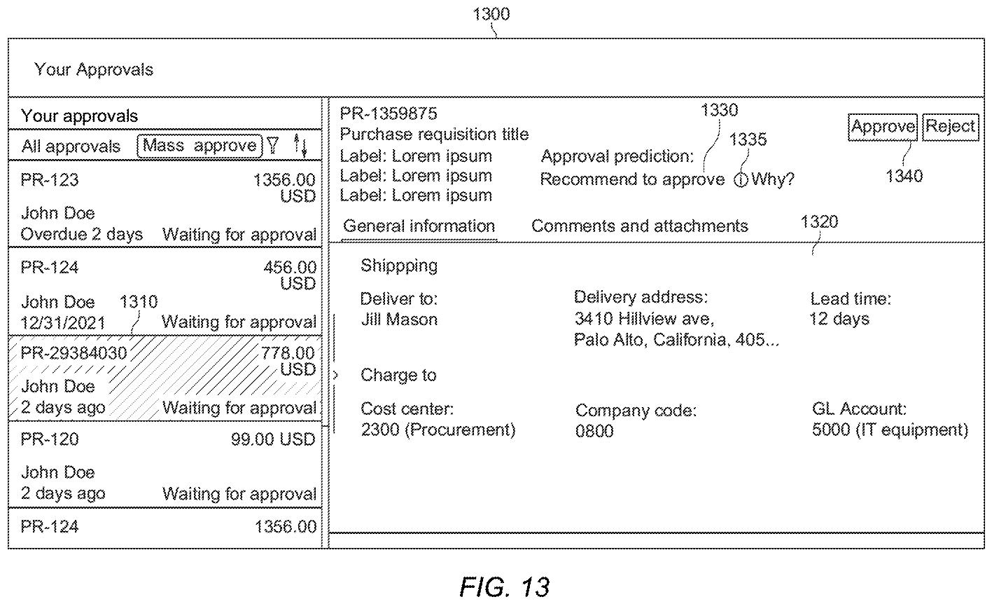

FIG. 13 is a view of interface 1300 displaying details of a particular purchase requisition according to some embodiments. In some examples, an approver selects a purchase requisition from list 1010 of interface 1000 and is presented with interface 1300 in response.

Purchase requisition 1310 is highlighted and details 1320 thereof are presented. Also presented is recommendation 1330 which is determined based on a classification and confidence level. The classification and confidence level are determined based on inputting data of the purchase requisition to a trained model as described above. For example, a confidence level threshold may be predefined, and a “Recommend to approve” recommendation is presented if the classification is Approved and the confidence level exceeds the confidence level threshold.

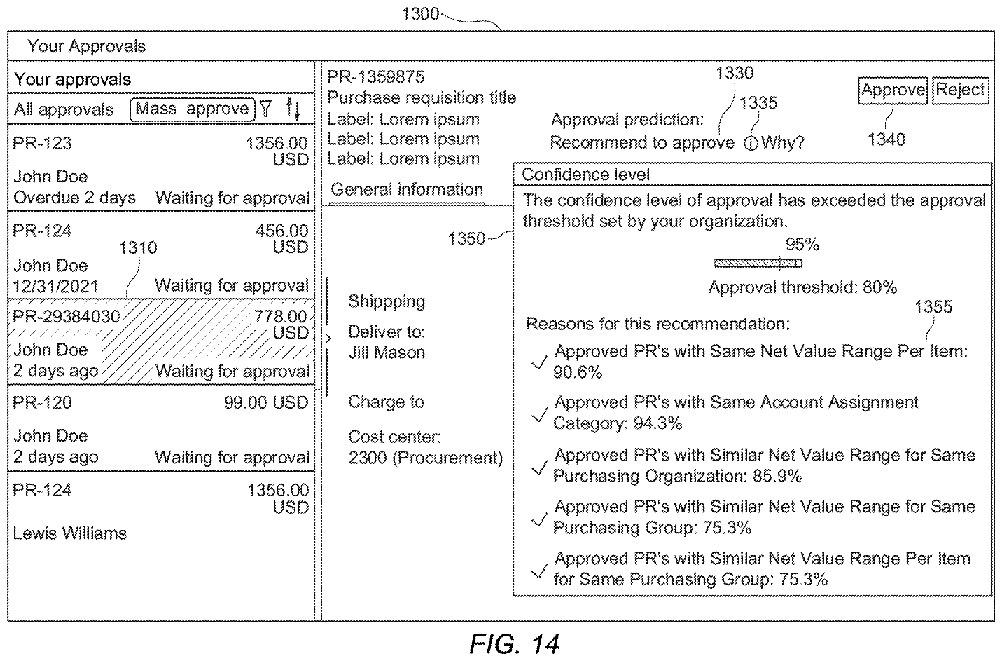

Selection of information icon 1335 cause presentation of window 1350 of FIG. 14. Window 1350 presents features and feature approval ratios 1355 based on feature contributions as described above. Such information may be helpful to the approver in determining which of Approve/Reject controls 1340 to select.

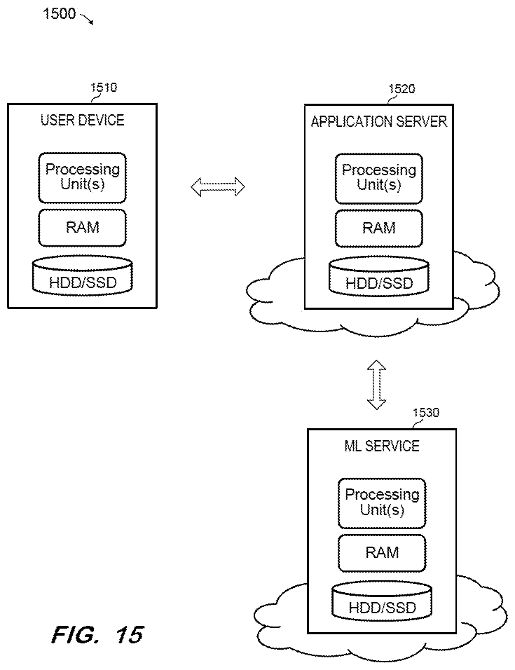

FIG. 15 is a block diagram of cloud-based architecture 1500 according to some embodiments. Application server 1520 and machine learning service 1530 may comprise cloud-based compute resources, such as one or more virtual machines, allocated by a public cloud provider providing self-service and immediate provisioning, autoscaling, security, compliance and identity management features.

A user may operate user device 1510 to interact with user interfaces of a service or application provided by application server 1520. Each of these services or applications may operate in conjunction with data stored local and/or on one or more remote data storage systems (not shown). Machine learning service 1530 may provide classification model instantiation, training and inference as well as determination of feature contributions and per-feature approval ratios as described herein.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
receive input data comprising a value for each of a plurality of features;
input the input data to a trained classification model to determine a label and a confidence level associated with the label;
determine a contribution of each of the plurality of features of the input data to the determined label based on the trained classification model and the determined label;
determine a set of the plurality of features based on the determined contributions;
determine a plurality of labeled data instances, each of the plurality of labeled data instances comprising a value for each of the plurality of features and a fixed label;
for each feature of the set, determine a ratio of a number of the plurality of labeled data instances having a same value as the input data and a fixed label which is the determined label to a number of the plurality of labeled data instances having the same value as the input data and a fixed label which is not the determined label;
present the determined label and the confidence level; and
present an indication of each feature of the set and its determined ratio based on its determined contribution.

2. A system according to claim 1, the at least one processing unit to execute the processor-executable program code to cause the system to:
determine a set of labeled data;
generate a set of labeled training data instances and a set of labeled testing data instances from the set of labeled data; and
train the classification model based on the set of labeled training data instances and the set of labeled testing data instances.

3. A system according to claim 1, wherein presentation of an indication of each feature of the set and its determined ratio based on its determined contribution comprises:
presentation of the indication of each feature of the set and its determined ratio in descending order of determined contributions.

4. A system according to claim 3, the at least one processing unit to execute the processor-executable program code to cause the system to:
present the determined contributions.

5. A system according to claim 1, wherein determination of the set of the plurality of features based on the determined contributions comprises:
determination of the features associated with largest contributions.

6. A system according to claim 5, wherein presentation of an indication of each feature of the set and its determined ratio based on its determined contribution comprises:
presentation of the indication of each feature of the set and its determined ratio in descending order of determined contributions.

7. A system according to claim 6, the at least one processing unit to execute the processor-executable program code to cause the system to:
present the determined contributions.

8. A method comprising:
receiving input data comprising a value for each of a plurality of features;
determining a label and a confidence level associated with the input data using a trained classification model;
determining a contribution of each of the plurality of features of the input data to the determined label based on the trained classification model and the determined label;
determining a set of the plurality of features based on the determined contributions;
determining a plurality of labeled data instances, each of the plurality of labeled data instances comprising a value for each of the plurality of features and a label;
for each feature of the set, determine a ratio of a number of the plurality of labeled data instances having a same value as the input data and a label which is the determined label to a number of the plurality of labeled data instances having the same value as the input data and a label which is not the determined label;
present the determined label and the confidence level; and
present an indication of each feature of the set, its determined ratio and its determined contribution.

9. A method according to claim 8, further comprising:
determining a set of labeled data;
generating a set of labeled training data instances and a set of labeled testing data instances from the set of labeled data; and
training the classification model based on the set of labeled training data instances and the set of labeled testing data instances.

10. A method according to claim 8, wherein presenting an indication of each feature of the set, its determined ratio and its determined contribution comprises:
presentation of the indication of each feature of the set and its determined ratio in descending order of determined contributions.

11. A method according to claim 8, wherein determining the set of the plurality of features based on the determined contributions comprises:
determining the features associated with largest contributions.

12. A method according to claim 11, wherein presenting an indication of each feature of the set, its determined ratio and its determined contribution comprises:
presenting the indication of each feature of the set and its determined ratio in descending order of determined contributions.

13. A non-transitory medium storing program code executable by at least one processing unit of a computing system to cause the computing system to:
receive input data comprising a value for each of a plurality of features;
input the input data to a trained classification model to determine a label and a confidence level associated with the label;
determine a contribution of each of the plurality of features of the input data to the determined label based on the trained classification model and the determined label;
determine a set of the plurality of features based on the determined contributions;
determine a plurality of labeled data instances, each of the plurality of labeled data instances comprising a value for each of the plurality of features and a fixed label;
for each feature of the set, determine a ratio of a number of the plurality of labeled data instances having a same value as the input data and a fixed label which is the determined label to a number of the plurality of labeled data instances having the same value as the input data and a fixed label which is not the determined label;
present the determined label and the confidence level; and
present an indication of each feature of the set and its determined ratio based on its determined contribution.

14. A medium according to claim 13, the program code executable by at least one processing unit of a computing system to cause the computing system to:
determine a set of labeled data;
generate a set of labeled training data instances and a set of labeled testing data instances from the set of labeled data; and
train the classification model based on the set of labeled training data instances and the set of labeled testing data instances.

15. A medium according to claim 13, wherein presentation of an indication of each feature of the set and its determined ratio based on its determined contribution comprises:
presentation of the indication of each feature of the set and its determined ratio in descending order of determined contributions.

16. A medium according to claim 15, the program code executable by at least one processing unit of a computing system to cause the computing system to:
present the determined contributions.

17. A medium according to claim 13, wherein determination of the set of the plurality of features based on the determined contributions comprises:
determination of the features associated with largest contributions.

18. A medium according to claim 17, wherein presentation of an indication of each feature of the set and its determined ratio based on its determined contribution comprises:
presentation of the indication of each feature of the set and its determined ratio in descending order of determined contributions.

19. A medium according to claim 18, the program code executable by at least one processing unit of a computing system to cause the computing system to:
present the determined contributions.

20. A medium according to claim 13, wherein determination of the contribution of each of the plurality of features of the input data to the determined label comprises adding the contribution of one of the features to the contribution of another one of the features.
